(19) United States
(12) Patent Application Publication
(10) Pub. No.: US 2011/0041167 A1
(43) Pub. Date: Feb. 17, 2011

(54) TECHNIQUES FOR PROVIDING SECURE COMMUNICATIONS AMONG CLIENTS WITH EFFICIENT CREDENTIALS MANAGEMENT

(75) Inventor: Nhut NGUYEN, Richardson, TX (US)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/856,406

(22) Filed: Aug. 13, 2010

Related U.S. Application Data
(60) Provisional application No. 61/234,607, filed on Aug. 17, 2009.

(51) Int. Cl. G06F 21/20

(52) U.S. Cl. 726/6

(57) ABSTRACT

A method, server and client for protecting communications among a plurality of clients, for use in a networked communication system comprising a server and the plurality of clients, the plurality of clients comprising at least a first client and a second client, are provided. The method includes communicating, from the first client to the server, a request for a credential token for a communication between the first client and the second client, selecting, by the server, the credential token for the communication between the first client and the second client, communicating, from the server to each of the first client and the second client, the selected credential token, and communicating, between the first client and the second client using security algorithms and information contained in the credential token received from the server.

### CROSS-REFERENCE TO RELATED APPLICATION

This application claims the benefit under 35 U.S.C. §119(e) of a U.S. Provisional application filed on Aug. 17, 2009 in the U.S. Patent and Trademark Office and assigned Ser. No. 61/234,607, the entire disclosure of which is hereby incorporated by reference.

### BACKGROUND OF THE INVENTION

1. Field of the Invention

The present invention relates to techniques for providing secure communications among clients. More particularly, the present invention relates to techniques for providing secure communications among clients with efficient credentials management.

2. Description of the Related Art

In a networked environment where information is exchanged over public networks, security attacks on communications are a major concern. To protect the security of information being exchanged among participating entities in the network, various security mechanisms have and are being developed and deployed. The main properties of information that need to be protected include confidentiality, integrity, authenticity and availability. Confidentiality may be protected using encryption techniques, while other techniques, such as keyed hashing, are typically used to protect integrity and authenticity.

One of the major challenges in deploying security protection mechanisms for a networked communication system is the management of credentials, such as cryptographic keys, that are necessary for cryptographic techniques, such as encryption and keyed hashing. If keys are compromised, the security of the system is compromised. Furthermore, management of the various credentials for communicating with multiple other entities could be complex and resource consuming for communicating clients and thus could be prohibitive in a resource constrained environment, such as where mobile terminals are involved.

For client-server communications, such as web browsing, the number of servers is typically much smaller than the number of clients. Servers tend to have more resources and are better suited to managing complex and computing intensive security credentials, such as digital certificates and digital signatures. However, for direct client-client communications, and especially when the clients are mobile terminals, such prior art techniques are impractical due to the sheer numbers and the limited resources of the clients. For instance, it is impractical to issue digital certificates to millions and millions of mobile phones.

Thus, there is a need for innovative techniques to provide secure client-client communications while addressing the challenges of managing credentials in clients, especially in networked communication systems where mobile terminals are communicating entities.

### SUMMARY OF THE INVENTION

An aspect of the present invention is to address at least the above-mentioned problems and/or disadvantages and to provide at least the advantages described below. Accordingly, an aspect of the present invention is to provide techniques for providing secure communications among clients with efficient credentials management.

In accordance with an aspect of the present invention, a method for protecting communications among a plurality of clients, for use in a networked communication system comprising a server and the plurality of clients, the plurality of clients comprising at least a first client and a second client, is provided. The method includes communicating, from the first client to the server, a request for a credential token for a communication between the first client and the second client, selecting, by the server, the credential token for the communication between the first client and the second client, communicating, from the server to each of the first client and the second client, the selected credential token, and communicating, between the first client and the second client using security algorithms and information contained in the credential token received from the server.

In accordance with another aspect of the present invention, a server apparatus for protecting communications among a plurality of clients, for use in a networked communication system comprising the server and the plurality of clients, the plurality of clients comprising at least a first client and a second client, is provided. The apparatus includes a token server for receiving a request from a first client for a credential token for a communication between the first client and the second client, for selecting the credential token for the communication between the first client and the second client, and for transmitting the selected credential token to each of the first client and the second client.

In accordance with still another aspect of the present invention, a client apparatus for protecting communications between the client and at least one counterpart client, for use in a networked communication system comprising the server, the client, and at least one counterpart client, is provided. The apparatus includes a token client for receiving a credential token from a server for a communication between the client and the counterpart client, a credential table for storing the received credential token from the server and the associations with communicating clients, and a communication unit for communicating between the client and the counterpart client using security algorithms and information contained in the received credential token.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an exemplary networked communication system where multiple clients and servers are interconnected according to an exemplary embodiment of the present invention;

FIG. 2 illustrates secure communications between clients using credential tokens according to an exemplary embodiment of the present invention; and

FIG. 3 illustrates a format of a credential token according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention described below relate to techniques for providing secure communications among clients with efficient credentials management. It should be understood that the following description might refer to terms utilized in various standards merely for simplicity of explanation. However, this description should not be interpreted as being limited to any such standards. Independent of the mechanism used to provide secure communications among clients with efficient credentials management, it is advantageous for that ability to conform to a standardized mechanism.

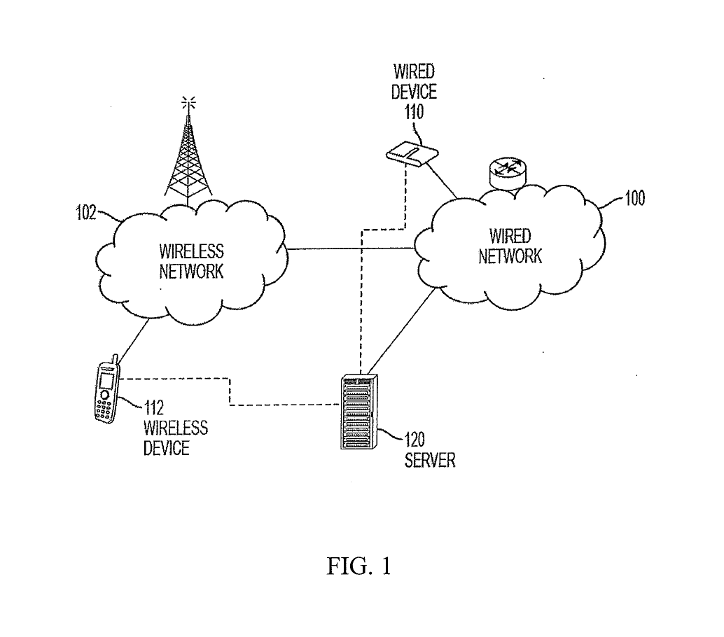

An example of a networked communication system in which the exemplary embodiments of the present invention are implemented is described below with reference to FIG. 1.

FIG. 1 illustrates an exemplary networked communication system where multiple clients and servers are interconnected according to an exemplary embodiment of the present invention.

Referring to FIG. 1, the exemplary networked communication system, in which the exemplary embodiments of the present invention are implemented, includes wired network 100, wireless network 102, wired device 110, wireless device 112, and server 120. Each of wired device 110 and wireless device 112 has associated therewith a client (not shown) that communicates security information with server 120. Hereafter, wired device 110 and wireless device 112 may be referred to as clients. Further, wireless device 112 may have limited resources (e.g., computing power, memory, energy, etc.) while wired device 110 may not have these constraints. In FIG. 1, solid lines represent physical connectivity and dotted lines represent logical connectivity.

The exemplary networked communication system illustrated in FIG. 1 is merely one of a number of possible implementations. For example, one of wired network 100 and wireless network 102 may be omitted. Alternatively, wired network 100 and wireless network 102 may be combined. Further, while server 120 is shown as connected to wired network 100, the server 120 may alternatively or additionally be directly connected to wireless network 102.

In addition, while only one of each of wired network 100, wireless network 102, wired device 110, wireless device 112, and server 120 are shown for simplicity, the networked communication system may include any number of each of wired network 100, wireless network 102, wired device 110, wireless device 112, and server 120.

Client-server communications are widely used in networked communication systems, such as the networked communication system illustrated in FIG. 1, and techniques to protect client-server communications are known in the art. Herein, exemplary embodiments of the present invention are described in the context of communications between a server and a client being secure. However, there are applications that require direct communications among clients in a networked communication system, such as the networked communication system illustrated in FIG. 1, to be secure, and thus such communications among clients also require security protection.

One exemplary application is the use of many user interface agents running on different devices exchanging sensitive information with each other to provide a rich user experience to the users. Such an application is being developed by the Moving Picture Experts Group (MPEG) standardization body. Here, the user interface framework standard is referred to as MPEG-U. However, due to resource limitations of the devices associated with the clients, especially wireless devices, the same techniques used to securely protect the communications between a client and the server may not be practical or applicable. For instance, public key cryptography based digital certificates and Secured Socket Layer (SSL) are widely used to protect client-server communications, but these techniques may not be efficient if used for client-client communications to provide the rich user experience made possible with MPEG-U.

Exemplary embodiments of the present invention includes techniques for protecting client-client communications while taking into account the resource constraints of devices to address the above mentioned challenges. These techniques are based on a concept of credential tokens.

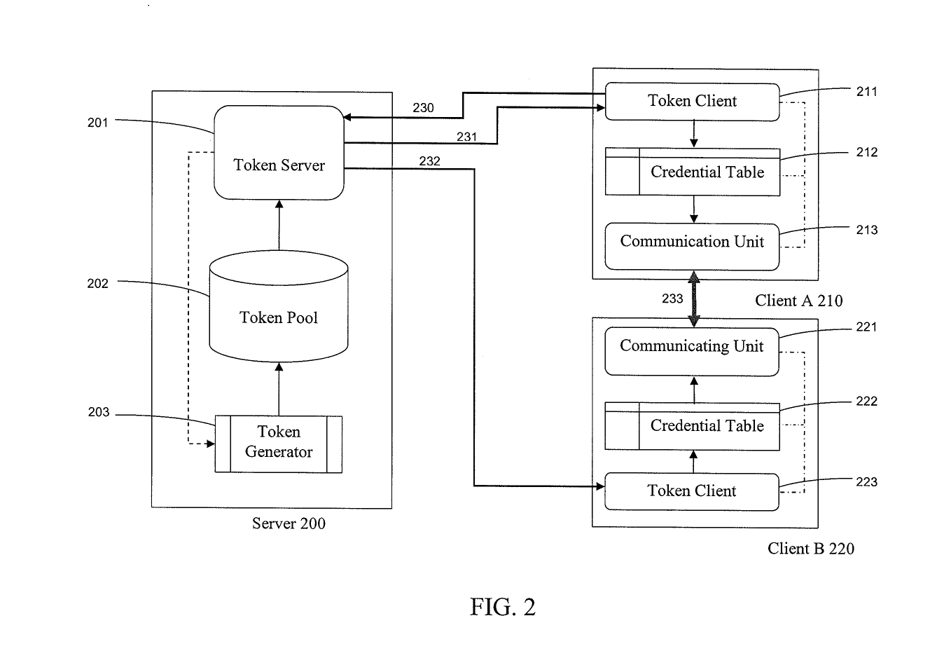

FIG. 2 illustrates secure communications between clients using credential tokens according to an exemplary embodiment of the present invention.

Referring to FIG. 2, server 200, client A 210, and client B 220 are shown. Server 200 may be server 120 of the networked communication system illustrated in FIG. 1. Each of client A 210 and client B 220 may be associated with one of wired device 110 and wireless device 112 of the networked communication system illustrated in FIG. 1.

Server 200 includes token server 201, credential token pool 202 and credential token generator 203. Token server 201 is the central entity that is responsible for managing and issuing credential tokens to all clients (such as client A 210) that need to communicate with another client (such as client B 220) in the networked communication system. Token server 201 interacts with the token client of a client to receive requests as well as to issue credential tokens to a requesting token client using secure communications provided by means that are outside the scope of this disclosure. Token server 201 is also responsible for invalidating a credential token in a case where the credential token has been compromised. Token server 201 uses token pool 202 to manage credential tokens of all clients in the networked communication system. Token server 201 is additionally responsible for maintaining a sufficient number of credential tokens in token pool 202 for use by all clients. For efficiency reasons, token pool 202 may be organized as a first-in-first-out queue. The credential tokens may be generated offline, during off-peaks hours or on-demand by credential token generator 203. For instance, when the number of credential tokens in the token pool reaches a certain threshold the server will send a signal to credential token generator 203 to request more tokens to replenish the pool. Token generator 203 may be designed in a modular manner and is flexible so that new credential algorithms may be accommodated easily by plugging in new modules. The credential tokens may include transient credential information that is generated by token server 201 and given to two or more communicating clients to use when communicating there between.

To further enhance the security of these techniques in a flexible manner, credential tokens may be used by a client in various modes depending on the requirements of a particular information exchange between two or more clients. The various modes include a one-time mode, a limited-time mode, and a count-based mode. In the one-time mode, the credential token is used for a one time exchange between two or more communication clients. In the limited-time mode, the credential token can be used only for a limited period of time. Here, the expiration of a token is set by token server 201 and may be timer based (e.g., the token expires in 10 minutes) or clock based (e.g., the token expires at 12:00AM). In the count-based mode, the credential token is valid for a certain number of uses. The one-time mode is a special case of the count-based mode.

Depending on the security needs of a networked communication system, the validity of credential tokens may or may not be extended via signaling between token server 201 and token clients.

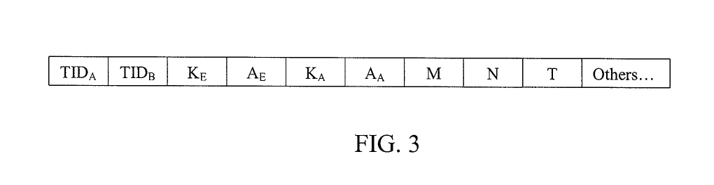

An example of a credential token format is described below with reference to FIG. 3.

FIG. 3 illustrates a format of a credential token according to an exemplary embodiment of the present invention.

Referring to FIG. 3, TID_{A} denotes a Temporary IDentifier (ID) of Client A, TID_{B} denotes a Temporary ID of Client B, K_{E} denotes an Encryption key, A_{E} denotes an Encryption algorithm ID, K_{A} denotes an Authentication key, AA denotes an Authentication Algorithm ID, M denotes a Token usage mode, N denotes the Number of uses allowed, T denotes the Time limit (e.g. how long a client can use this token), and Others denotes other fields.

Note that the credential token of FIG. 3 may be used for any security mechanisms as needed, and is not only limited to encryption and authentication. As mentioned previously, the techniques described herein are designed to be flexible to accommodate yet to be developed security algorithms by having a modular token generator 203 that can plug-in new credential algorithms as needed. Furthermore additional fields can be added to the credential token format of FIG. 3 to ease or facilitate security operations.

Returning to FIG. 2, client A 210 includes token client 211, credential table 212, and communication unit 213. Similarly, client B 220 includes token client 221, credential table 222, and communication unit 223.

Consider a case where client A 210 desires to communicate with client B 220. Here, token client 211 of client A 210 sends a request to token server 201 in communication 230. The request includes the real ID information of client A 210 and that of client B 220. If desired, the usage mode for the requested credential token may be also specified in the request. Token server 210 selects a credential token from token pool 202, assigns a temporary ID to both client A 210 and client B 220 and records the association between the temporary IDs and client IDs in a table (not shown) for further reference. Token server 210 then sends the credential token to client A 210 in communication 231 and to client B 220 in communication 232 in a response to the request from client A 210. Token client 211 of client A 210 stores the received credential token in its credential table 212. Similarly, token client 221 of client B stores the received token in its credential table 222.

Herein, it is assumed that communications between token server 201 and client A 210 and client B 220 are secured by other means, which are not in the scope of the present disclosure. Note that the association between the temporary ID and a client ID is known only to token server 201 and the communicating clients, namely client A 210 and client B 220. This property enhances the security of the client ID information. Further expansion of the temporary ID to include an ID of communication units to further enhance the security of the networked communication system may also be implemented. In this case, each communication unit in a client, such as communication unit 213 of client A 210 and communication unit 223 of client B 223, will have a unique temporary ID when communicating with another communication unit in another client.

After the token has been received by both client A 210 and client B 220, the communication units, namely communication unit 213 of client A 210 and communication unit 223 of client B 223, may communicate with each other in communication 233. Communication unit 213 in client A 210 may use cryptographic information contained in the credential token stored in credential table 212 to secure communications with client B 220, which has received that same credential token. An exemplary credential token may contain a symmetric encryption key (K_{E}) and an encoded encryption algorithm (e.g., AES-128) for confidentiality protection. Similarly, an exemplary credential token may contain an authentication key (K_{A}) and an encoded integrity and authenticity protection algorithm (e.g. HMAC-SHA1).

If the credentials used by client A 210 and client B 220 are compromised for some reason, token server 201 may instruct client A 210 and client B to invalidate the current credentials and request new ones. Likewise, if new credentials algorithms need to be applied to current communications, the token server 201 may also instruct client A 210 and client B 220 to apply new credentials.

With these techniques clients in a networked communication system do not have to deal with the complex issue of credential management and yet the clients still have the cryptographic credentials to secure communications with other clients.

Certain aspects of the present invention may also be embodied as computer readable code on a computer readable recording medium. A computer readable recording medium is any data storage device that can store data, which can be thereafter read by a computer system. Examples of the computer readable recording medium include Read-Only Memory (ROM), Random-Access Memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for protecting communications among a plurality of clients, for use in a networked communication system comprising a server and the plurality of clients, the plurality of clients comprising at least a first client and a second client, the method comprising:
communicating, from the first client to the server, a request for a credential token for a communication between the first client and the second client;
selecting, by the server, the credential token for the communication between the first client and the second client;
communicating, from the server to each of the first client and the second client, the selected credential token; and
communicating, between the first client and the second client using security algorithms and information contained in the credential token received from the server.

2. The method of claim 1, wherein the request for the credential token for the communication between the first client and the second client includes a real IDentifier (ID) of each of the first client and the second client.

3. The method of claim 2, wherein the request for the credential token for the communication between the first client and the second client further includes a usage mode for the credential token.

4. The method of claim 1, further comprising:
assigning, by the server, a temporary IDentifier (ID) to each the first client and the second client,
wherein the selected credential token includes the temporary ID.

5. The method of claim 1, wherein the credential token comprises at least one of a temporary IDentifier (ID) of the first client, a temporary ID of the second client, an encryption key, an encryption algorithm ID, an authentication key, an authentication algorithm ID, a token usage mode, a number of uses allowed, and a time limit.

6. The method of claim 1, wherein if the credential token is compromised or if new security mechanisms are to be used, instructions to invalidate the credential token and request a new credential token is communicated from the server to each of the first client and the second client.

7. The method of claim 1, wherein the server selects the credential token for the communication between the first client and the second client from a pool of credential tokens.

8. The method of claim 7, further comprising:
generating, by the server, credential tokens for the pool of credential tokens.

9. The method of claim 8, wherein credential tokens are generated for the pool of credential tokens on demand when a threshold of available tokens is reached, or during off-peak hours.

10. A server apparatus for protecting communications among a plurality of clients, for use in a networked communication system comprising the server and the plurality of clients, the plurality of clients comprising at least a first client and a second client, the apparatus comprising:
a token server for receiving a request from a first client for a credential token for a communication between the first client and the second client, for selecting the credential token for the communication between the first client and the second client, and for transmitting the selected credential token to each of the first client and the second client.

11. The apparatus of claim 10, wherein the request for the credential token for the communication between the first client and the second client includes a real IDentifier (ID) of each of the first client and the second client.

12. The apparatus of claim 11, wherein the request for the credential token for the communication between the first client and the second client further includes a usage mode for the credential token.

13. The apparatus of claim 10, wherein the token server assigns a temporary IDentifier (ID) to each the first client and the second client, and wherein the selected credential token includes the temporary ID.

14. The apparatus of claim 10, wherein the credential token comprises at least one of a temporary IDentifier (ID) of the first client, a temporary ID of the second client, an encryption key, an encryption algorithm ID, an authentication key, an authentication algorithm ID, a token usage mode, a number of uses allowed, and a time limit.

15. The apparatus of claim 10, wherein the token server determines if the selected credential token is compromised or if new security mechanisms are to be used, and if the token server determines the selected credential token is compromised or if new security mechanisms are to be used, the token server transmits, to each of the first client and the second client, instructions to invalidate the credential token and request a new credential token.

16. The apparatus of claim 10, further comprising a token pool for storing a plurality of credential tokens,
wherein the token server selects the credential token for the communication between the first client and the second client from the pool of credential tokens.

17. The apparatus of claim 10, further comprising a token generator for generating credential tokens.

18. The apparatus of claim 17, wherein token generator is activated on demand when a threshold of available tokens is reached, or during off-peak hours.

19. A client apparatus for protecting communications between the client and at least one counterpart client, for use in a networked communication system comprising the server, the client, and at least one counterpart client, the apparatus comprising:
a token client for receiving a credential token from a server for a communication between the client and the counterpart client;
a credential table for storing the received credential token from the server and the associations with communicating clients; and
a communication unit for communicating between the client and the counterpart client using security algorithms and information contained in the received credential token.

20. The apparatus of claim 19, wherein the token client transmits a request to the server for the credential token for the communication between the client and the counterpart client.

21. The apparatus of claim 20, wherein the request for the credential token for the communication between the client and the counterpart client includes a real IDentifier (ID) of each of the client and the counterpart client.

22. The apparatus of claim 21, wherein the request for the credential token for the communication between the client and the counterpart client further includes a usage mode for the credential token.

23. The apparatus of claim 19, wherein the credential token comprises at least one of a temporary IDentifier (ID) of the client, a temporary ID of the counterpart client, an encryption key, an encryption algorithm ID, an authentication key, an authentication algorithm ID, a token usage mode, a number of uses allowed, and a time limit.

24. The apparatus of claim 19, wherein the token client receives instructions to invalidate the credential token and request a new credential token.
